(19) United States
(12) Patent Application Publication
(10) Pub. No.: US 2021/0183190 A1
(43) Pub. Date: Jun. 17, 2021

(54) AUTOMATICALLY PROVIDING ACCESS TO VENDOR APPLICATION BY USING MOBILE CREDENTIALS

(71) Applicant: Carrier Corporation, Palm Beach Gardens, FL (US)

(72) Inventors: Sumanth Kumar Mukundala, Hyderabad, Telangana (IN); Jonah J. Harkema, Newberg, OR (US)

(21) Appl. No.: 17/253,574

(22) PCT Filed: Sep. 10, 2019
(86) PCT No.: PCT/US2019/050273

§ 371 Date: Dec. 17, 2020

(30) Foreign Application Priority Data
Sep. 10, 2018 (IN) 201811033918

(51) Int. Cl. G07C 9/27; G06Q 50/12; G07C 9/00; G07C 9/20; G06Q 30/02

(52) U.S. Cl. CPC G07C 9/27; G06Q 50/12; G06Q 30/0236; G07C 9/215; G06Q 30/0235; G07C 9/00904

(57) ABSTRACT

A method of automatically providing promotions to hotel guests using mobile credentials is provided. The method includes receiving, by a vendor application of a vendor, a request from a requestor to access the vendor application to perform a business transaction between the requestor and the vendor. A mobile credential assigned to the requestor for unlocking an access control device is received by the vendor application. It is determined whether the mobile credential assigned to the requestor is valid. Based at least in part on determining that the mobile credential is valid, the mobile credential is accepted by the vendor application and the requestor is provided access to the vendor application to perform the business transaction.

### BACKGROUND

The subject matter disclosed herein generally relates to the field of access control systems, and more particularly to an apparatus and method for automatically providing access to vendor applications by using mobile credentials.

Businesses often have arrangements with other businesses to provide discounts or other vendor promotions and free service to consumers and employees while they are either using the service (such as a guest at a hotel) or are employed at the business. For example, a hotel guest may be eligible for a discount on a pizza at a local restaurant, or free movies on a movie streaming service. Contemporary methods of providing the vendor promotions to hotel guests include providing paper coupons that can be presented to a business when requesting the discount. Other methods include providing the hotel guest with an electronic coupon, or a location of an electronic coupon, that has a bar code that can be scanned by the business providing the promotion. Other methods of a hotel guest taking advantage of a vendor promotion is for the hotel to provide the hotel guest with a promotion code that the hotel guest can enter when making an on-line purchase. In all of these cases, hotel guests have to take a manual action to take advantage of the vendor promotion offered by the hotel.

### BRIEF SUMMARY

According to an embodiment, a method of automatically providing vendor promotions to requestors is provided. The method includes receiving, by a vendor application of a vendor, a request from a requestor to access the vendor application to perform a business transaction between the requestor and the vendor. A mobile credential assigned to the requestor for unlocking an access control device is received by the vendor application. It is determined whether the mobile credential assigned to the requestor is valid. Based at least in part on determining that the mobile credential is valid, the mobile credential is accepted by the vendor application and the requestor is provided access to the vendor application to perform the business transaction.

In addition to one or more of the features described above or below, or as an alternative, further embodiments of the method may include that the providing the requestor access to the vendor application includes applying a vendor promotion to the vendor transaction between the requestor and the vendor.

In addition to one or more of the features described above or below, or as an alternative, further embodiments of the method may further include denying the requestor access to the vendor application based at least in part on determining that the mobile credential is invalid.

In addition to one or more of the features described above or below, or as an alternative, further embodiments of the method may include that the mobile credential is invalid.

In addition to one or more of the features described above or below, or as an alternative, further embodiments of the method may include that the requestor is a hotel guest of a hotel and the access control device is located at the hotel.

In addition to one or more of the features described above or below, or as an alternative, further embodiments of the method may include that the determining includes transmitting a validation request to a mobile credential module that includes valid mobile credentials assigned to hotel guests of the hotel. The validation request includes the mobile credential of the requestor. In response to the transmitting, a status of valid or invalid is received from the mobile credential module.

In addition to one or more of the features described above or below, or as an alternative, further embodiments of the method may include that the mobile credential is valid between a time that the hotel guest checks into the hotel and a time that the hotel guest checks out of the hotel, and invalid otherwise.

In addition to one or more of the features described above or below, or as an alternative, further embodiments of the method may include that the hotel guest initiates the request from a hotel application and the promotion was previously negotiated between the hotel and the vendor.

In addition to one or more of the features described above or below, or as an alternative, further embodiments of the method may include providing the hotel guest access to a hotel network without any login credentials based at least in part on determining that the mobile credential is valid; and requiring the hotel guest to provide login credentials to access the hotel network based at least in part on determining that the mobile credential is not valid.

In addition to one or more of the features described above or below, or as an alternative, further embodiments of the method may include that providing the requestor access to the vendor application to perform the business transaction is further based at least in part on determining at least one of: the requestor is within range of a radio frequency transmission, the requestor is within range of a wireless network, the requestor is within a first specified distance of a geographic location, and the requestor is within a second specified distance of a device that uses mobile credentials. The requestor is not provided access to the vendor application otherwise.

In addition to one or more of the features described above or below, or as an alternative, further embodiments of the method may include that the requestor is provided access to the vendor application to perform the business transaction further based at least in part on determining that a current time of day is within a specified time period. The requestor is not provided access to the vendor application otherwise.

In addition to one or more of the features described above or below, or as an alternative, further embodiments of the method may include that the business transaction is a purchase of a product or a service.

In addition to one or more of the features described above or below, or as an alternative, further embodiments of the method may include that the requestor is an employee and the access control device is a location in a building.

In addition to one or more of the features described above or below, or as an alternative, further embodiments of the method may include that the promotion is at least one of a free product, a discounted product, a free service, and a free product.

In addition to one or more of the features described above or below, or as an alternative, further embodiments of the method may include that wherein the access control device is located in an office building or a school campus.

According to another embodiment, a system is configured to automatically providing vendor promotions to requestors. The system includes a processor and a memory having computer-executable instructions that, when executed by the processor, cause the processor to perform operation. The operations include receiving, by a vendor application of a vendor, a request from a requestor to access the vendor application to perform a business transaction between the requestor and the vendor. A mobile credential assigned to the requestor for unlocking an access control device is received by the vendor application. It is determined whether the mobile credential assigned to the requestor is valid. Based at least in part on determining that the mobile credential is valid, the mobile credential is accepted by the vendor application and the requestor is provided access to the vendor application to perform the business transaction.

In addition to one or more of the features described above or below, or as an alternative, further embodiments of the system may include that the providing the requestor access to the vendor application includes applying a vendor promotion to the vendor transaction between the requestor and the vendor.

In addition to one or more of the features described above or below, or as an alternative, further embodiments of the system may further include denying the requestor access to the vendor application based at least in part on determining that the mobile credential is invalid.

In addition to one or more of the features described above or below, or as an alternative, further embodiments of the system may include that the requestor is a hotel guest of a hotel and the access control device is located at the hotel.

In addition to one or more of the features described above or below, or as an alternative, further embodiments of the system may include providing the hotel guest access to a hotel network without any login credentials based at least in part on determining that the mobile credential is valid; and requiring the hotel guest to provide login credentials to access the hotel network based at least in part on determining that the mobile credential is not valid.

Technical effects of embodiments of the present disclosure include the ability for a hotel guest to use vendor promotions provided by the hotel using a mobile credential assigned to the hotel guest. The hotel guest has no reason to enter discount coupons or promotional codes or vouchers as the system is completely automated. The system automatically detects the guest mobile credential and automatically offers the discount to the hotel guest when a vendor application is opened. Technical effects of embodiments also include the ability to limit the use of the vendor promotions to hotel guests during their stay at the hotel because once a hotel guest checks out the hotel the associated mobile credential is no longer valid.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

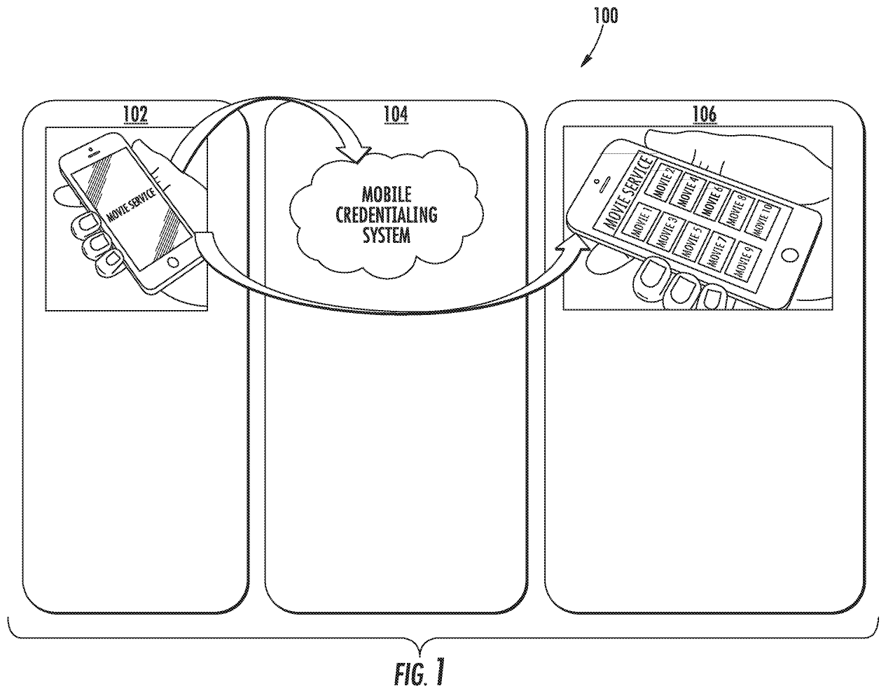

FIG. 1 illustrates a high level view of a method for automatically providing promotions to hotel guests using mobile credentials, in accordance with an embodiment of the disclosure;

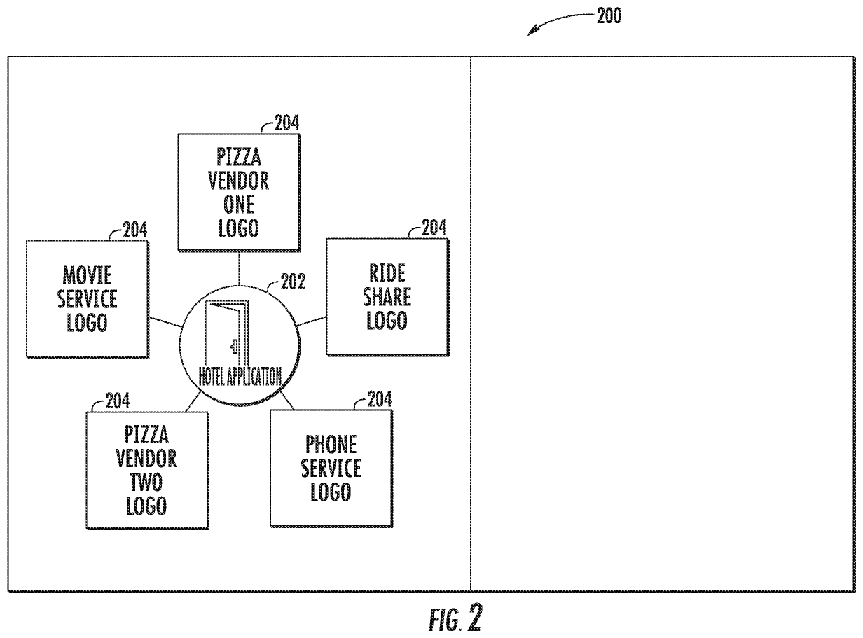

FIG. 2 illustrates a high level view of a system for automatically providing promotions to hotel guests using mobile credentials, in accordance with an embodiment of the disclosure;

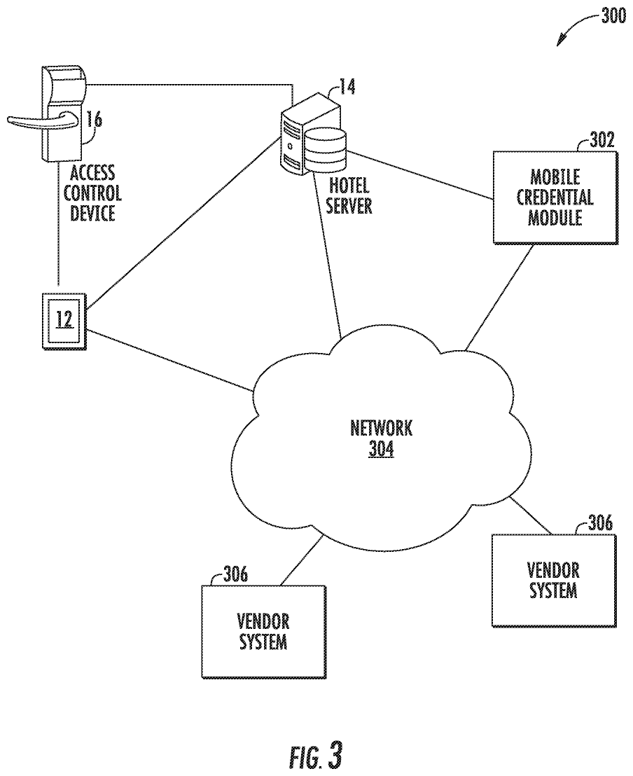

FIG. 3 illustrates a general schematic system diagram of system for automatically providing promotions to hotel guests using mobile credentials, in accordance with an embodiment of the disclosure;

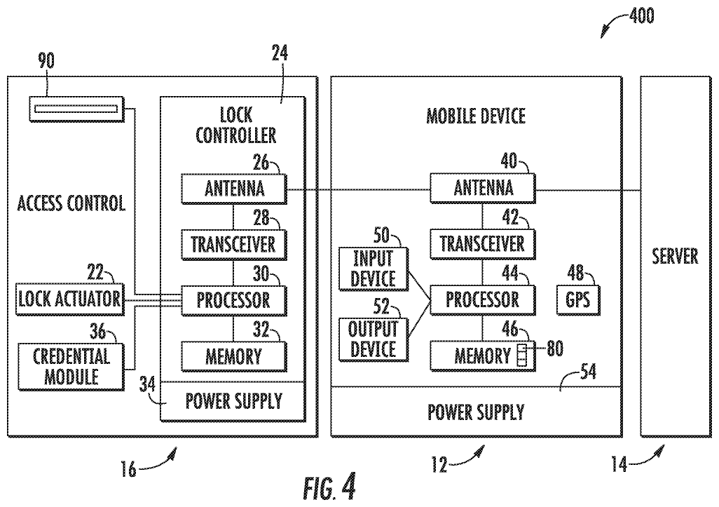

FIG. 4 illustrates a block diagram of an access control device, mobile device and server of the access control system of FIG. 3, in accordance with an embodiment of the disclosure; and

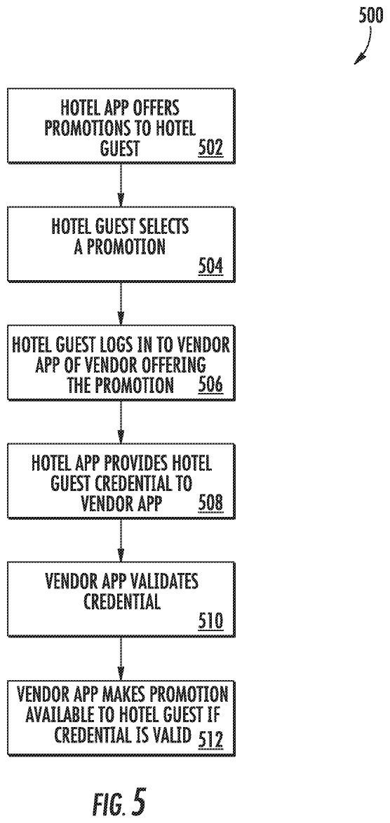

FIG. 5 is a flow diagram illustrating a method of automatically providing promotions to hotel guests using mobile credentials, in accordance with an embodiment of the disclosure.

### DETAILED DESCRIPTION

A detailed description of one or more embodiments of the disclosed apparatus and method are presented herein by way of exemplification and not limitation with reference to the Figures.

In accordance with an embodiment, promotions are automatically provided to hotel guests using mobile credentials. By using a mobile credential provided by the hotel, a hotel guest can automatically access the deals provided by the hotel when respective applications are accessed. Examples of vendor promotions, or deals, include, but are not limited to: buy one get one free offers, happy hour discounts or free drink/food item(s), pizza discounts or free pizza(s), free or discounted movie tickets, discounted or free taxi/ride sharing services, and free or reduced rate international calling. These deals can be utilized automatically by a guest of the hotel using a mobile credential that is assigned to the hotel guest when the hotel guest checks in to the hotel. In contemporary systems, a hotel guest can be assigned a mobile credential that is stored on a mobile device of the user and used by the hotel guest to unlock a lock on a room assigned to the hotel guest using the mobile device of the user. The mobile credential is typically only valid during the time that the hotel guest is staying at the hotel.

Turning now to FIG. 1, a high level view of a method 100 for automatically providing promotions to hotel guests using mobile credentials is generally shown, in accordance with an embodiment of the disclosure. In the embodiment shown in FIG. 1, at block 102, a hotel provides a vendor promotion, or offer, that in this example includes free movies from a movie service provider to guests staying at the hotel. In an embodiment, the vendor promotion is offered to the hotel guest via a mobile application of the hotel and the hotel guest logs on to the movie service provider application from the hotel application. At block 104 of FIG. 1, application access rights (e.g., the mobile credential assigned to the hotel guest) are provided to a mobile credential system to verify that the mobile credential is valid (e.g., that the hotel guest is still staying at the hotel). Based at least in part on the mobile credential being valid, a list of the free movies that are available to hotel guests is displayed on a user interface of the mobile device of the hotel guest as shown in block 106. If the mobile credential is determined to be invalid by the mobile credential system, then the list of free movies is not provided to the hotel guest. In an embodiment, when the hotel guest accesses the movie service provider application and the mobile credential is determined to be valid, the vendor promotion is automatically provided to the hotel guest.

Turning now to FIG. 2, a high level view of a system 200 for automatically providing vendor promotions to hotel guests using mobile credentials is generally shown, in accordance with an embodiment of the disclosure. The system 200 in FIG. 2 includes a hotel application 202 that is in communication with a plurality of vendor applications 204. In an embodiment, the hotel application 202 is implemented by a commercially available product such as DirectKey™ from Onity Incorporated. In another embodiment, the hotel application 202 is built specifically for a particular hotel and not commercially available.

The hotel application 202 can communicate with the different vendor applications 204 to establish vendor promotions that are available to guests of the hotel. For example, a pizza vendor can agree to provide a free small pizza with every large pizza delivered or a free bottle of soda with every two large pizzas, or any other promotion. In an embodiment, the vendor application associates the vendor promotions with the hotel application and each time that the vendor application is accessed by a hotel guest via the hotel application (e.g., executing on a mobile device of the hotel guest), the vendor application validates the credentials of the hotel guest and automatically applies the promotions to an order of the hotel guest.

Using a token, a program can be written between each vendor application 204, the hotel application 202, and the mobile credential server to provide security to share data and to provide a standard interface to share data. An example is having the vendor push a new discount (like 10% off of a 20 purchase) to a hotel server. The hotel server validates that information based on a pre-shared token that allows information to flow between a vendor system and the hotel server. The discount could then be sent to a hotel loyalty application from the hotel server. Another token could be shared between a mobile credential module and the vendor system that provides the vendor system with the ability to inspect all or part of the mobile credential when it is passed to vendor system from the hotel loyalty application.

In an embodiment, when a vendor application 204 is opened, or logged in to, by a hotel guest via the hotel application 202, the vendor application 204 communicates to the hotel application 202 to obtain a mobile credential assigned to the hotel guest. If the mobile credential of the hotel guest is valid, the vendor promotions for hotel guests are automatically applied to the hotel guest having the valid credential. For example, when a guest arrives at the hotel, the guest may opt-in to using the hotel loyalty application on their mobile device 12 and to opening the guest room door using mobile credentials. The mobile credentials may be downloaded to the hotel application, and the guest uses the mobile credentials with the hotel lock to enter the guest room. During dinner time, a notification about a discount at a local pizza delivery restaurant is sent to the user's mobile device 12. An alert may be displayed in the hotel loyalty application giving the hotel guest the ability to select this discount. The hotel guest indicates in the application that they want to use the discount, and the hotel loyalty application sends the guest to the website of the local pizza delivery restaurant and passes the guest room door credential along with all other relevant guest information to the website. The hotel guest then selects a pizza and requests delivery to the hotel. The local pizza delivery restaurant website validates the mobile credential which will validate that the guest is staying at the hotel and proceeds to giving the hotel guest the discount along with the order.

Turning now to FIG. 3, a general schematic diagram of system 300 for automatically providing promotions to hotel guests using mobile credentials is generally shown, in accordance with an embodiment of the disclosure. The system 300 includes a mobile device 12, an access control device 16, a mobile credential module 302, a network 304, and a plurality of vendor systems 306. It should be appreciated that while one access control device 16 is illustrated, the system 300 may include any number of access control devices 16. In addition, though two vendor systems 306 are shown, the system 300 may include any number of vendor systems 306. It should be appreciated that, although particular systems are separately defined in the schematic block diagram, each or any of the systems may be otherwise combined or separated via hardware and/or software. For example, computer instructions to implement the mobile credential module 302 can be located on and executed by the server 14.

In an embodiment, the access control device 16 includes a lock and controls access through a door. It should be appreciated that the system 300 may include any number of doors and rooms. Further, there may be multiple doors and access control devices 16 for each room.

For a selected period of time (e.g., a period of stay of a hotel guest at a hotel) the mobile device 12 associated with a hotel guest may be granted access to one or more access control devices 16 (e.g., the door lock on a hotel room assigned to the hotel guest). When a person checks in to the hotel, a mobile credential stored on their mobile device 12 is granted access to a room. There may be one or more mobile devices 12 assigned to a hotel room (e.g., one for each occupant of the room), thus embodiments disclosed herein may apply to multiple mobile devices 12 per room. A hotel guest uses the mobile device 12 to unlock and/or lock the access control device 16 operably connected to their assigned room. The state of the access control device 16 can be changed from locked to unlock through an access request from the mobile device 12 being sent to the access control device 16 via a short-range wireless communication interface. The short-range wireless communication interface can be implemented by any short-range wireless communication method known in the art such as, but not limited to: Wi-Fi, Bluetooth, Zigbee, and infrared. In an embodiment,

The mobile device 12 may store credentials (also referred to herein as “mobile credentials”) to unlock and/or lock the access control device 16. Some credentials may be used for multiple access control devices 16 if there are multiple access control devices 16 for a single assigned room or the hotel guest is assigned access to multiple rooms. For example, an access control device 16 operably connected to a hotel room and an access control device 16 operably connected to a hotel pool may respond to the same credential. Other credentials may be specific to a single access control device 16.

The mobile device 12 may transmit an access request to the access control device 16 via the short-range radio transmission interface when the mobile device 12 is placed proximate to (i.e., within the range of the short-range radio transmission interface) the access control device 16. The data may include credentials to grant access to a specific access control device 16. For example, for a period of stay of the hotel guest, the mobile device 12 may be granted access to a specific access control device 16. In an embodiment, the mobile device 12 is a wireless capable handheld device such as a smartphone that is operable to communicate with the server 14 via a wireless communication interface. The wireless communication interface may be implemented by any short or long-range wireless communication method known in the art over networks such as, but not limited to the Internet, a local area network (LAN), and a wide area network (WAN). Although the server 14 is depicted herein as a single device, it should be appreciated that the server 14 may alternatively be embodied as a multiplicity of systems, from which the mobile device 12 receives credentials and optionally other data.

In addition, the server 14 may provide credentials and other data such as firmware or software updates 116 to the access control device 16 via a communication interface. The communication interface may be implemented by any short or long-range wired or wireless communication method known in the art over networks such as, but not limited to the Internet, a local area network (LAN), and a wide area network (WAN).

The access control device 16 may be a wireless-capable, restricted-access, or restricted-use device such as a wireless lock, access control reader for building entry, and other restricted-use machine. The mobile device 12 submits credentials to the access control device 16, thereby selectively permitting a user to access or activate functions of the access control device 16. The mobile device 12 may, for example, submit a credential to an electromechanical lock to unlock it, and thereby gain access to a room at the hotel.

In accordance with an embodiment, the mobile credential module 302 is accessed by the vendor systems 306 via network 304 to validate mobile credentials of hotel guests. The mobile credential module 302 communicates with the server 14 to obtain valid mobile credentials of hotel guests via, for example, a communication interface that may be implemented by any short or long-range wired or wireless communication method known in the art over networks such as, but not limited to the Internet, a local area network (LAN), and a wide area network (WAN). In an embodiment, the mobile credential module 302 accesses the server 14 periodically to update a list of valid mobile credentials stored local to the mobile credential module 302. In another embodiment, the server 14 sends updates to the mobile credential module 302 periodically or in response to a change (added, removed, updated) of a mobile credential. In an embodiment, a starting and ending date for each mobile credential can also be supplied to the mobile credential module 302 so that it can automatically remove mobile credentials past the ending date. In another embodiment, the mobile credential module is executing on the server 14 and a single version of the data indicating valid mobile credentials is utilized by both the hotel server 14 and the mobile credential module 302. In a further embodiment, the mobile credential module 302 is executing on a processor remote from the server 14.

As shown in FIG. 3, the vendor systems 306 and the hotel server 14 are in communication via network 304, for example to set up promotions for hotel guests. Also as shown in FIG. 3, the vendor systems 306 are in communication with the mobile credential module 302 via network 304, for example to validate mobile credentials received by hotel guests. Also as shown in FIG. 3, the mobile device communicates with the vendor systems 306 via network 304. In an embodiment, the mobile device of a hotel guest is executing a hotel application, such as hotel application 202 of FIG. 2, and the hotel guest is presented with vendor promotions from vendors. When the hotel guest selects one of the vendor promotions, the hotel application initiates a vendor application, such as vendor application 204 of FIG. 2, on a vendor system 306.

In an embodiment, a token (or a unique ID, certificate, or key, etc.) is shared with a vendor system 306 and the hotel server 14 to allow communication of data that describes discounts between them. In another embodiment, there is a token between the mobile credential module 302 and the vendor system 306 that allows the vendor to inspect and validate all or part of the content of the mobile credential. The tokens may be shared ahead of time or retrieved in real-time during the validation process. Other integration technologies, such as security assertion markup language (SAML), JSON web token, and/or encryption may also be utilized by embodiments.

The network 304 shown in FIG. 3 can include one or more of any type of known networks including, but not limited to, a wide area network (WAN), a local area network (LAN), a global network (e.g. Internet), a virtual private network (VPN), and an intranet. The network 304 can include a private network in which access thereto is restricted to authorized members. The network 304 can be implemented using wireless networking technologies or any kind of physical network implementation known in the art. The components shown in FIG. 3 may be coupled to one or more other components through multiple networks (e.g., Internet, intranet, and private network) so that not all components are coupled to other components through the same network 304.

With reference to FIG. 4, a block diagram 400 of the access control device 16, the mobile device 12 of the hotel guest, and the server 14 is generally shown in accordance with an embodiment of the disclosure. The access control device 16 generally includes a lock actuator 22, a lock controller 24, a lock antenna 26, a lock transceiver 28, a lock processor 30, a lock memory 32, a lock power supply 34, a lock card reader 90 and a credential module 36. The access control device 16 may have essentially two readers, one reader 90 to read a physical key card and the credential module 36 to communicate with the mobile device 12 via the lock processor 30 and the transceiver 28 and antenna 26. The access control device 16 is responsive to credentials from the mobile device 12, and may, for example, be the lock of a turnstile or a door lock. Although the present disclosure focuses primarily on credentials for access control, it should be appreciated that other systems wherein credentials are transmitted from a mobile device to an access control device so as to identify the user to an online system or validate user access rights or permissions in an offline system will benefit here from.

Upon receiving and authenticating an appropriate credential from the mobile device 12 using the credential module 36, or after receiving card data from lock card reader 90, the lock controller 24 commands the lock actuator 22 to lock or unlock a mechanical or electronic lock. In this manner, a lock state of the access control device 16 changes from one state to another state. The lock controller 24 and the lock actuator 22 may be parts of a single electronic or electromechanical lock unit, or may be components sold or installed separately.

The lock transceiver 28 is capable of transmitting and receiving data to and from at least the mobile device 12. The lock transceiver 28 may, for instance, be a near field communication (NFC), Bluetooth, infrared, Zigbee, or Wi-Fi transceiver, or another appropriate wireless transceiver. The lock antenna 26 is any antenna appropriate to the lock transceiver 28. The lock processor 30 and lock memory 32 are, respectively, data processing, and storage devices. The lock processor 30 may, for instance, be a microprocessor that can process instructions to validate credentials and determine the access rights contained in the credentials or to pass messages from a transceiver to a credential module 36 and to receive a response indication back from the credential module 36. The lock memory 32 may be RAM, EEPROM, or other storage medium where the lock processor 30 can read and write data including but not limited to lock configuration options. The lock power supply 34 is a power source such as line power connection, a power scavenging system, or a battery that powers the lock controller 24. In other embodiments, the lock power supply 34 may only power the lock controller 24, with the lock actuator 22 powered primarily or entirely by another source, such as user work (e.g. turning a bolt).

While FIG. 4 shows the lock antenna 26 and the transceiver 28 connected to the processor 30, this is not to limit other embodiments that may have additional antenna 26 and transceiver 28 connected to the credential module 36 directly. The credential module 36 may contain a transceiver 28 and antenna 26 as part of the credential module. Or the credential module 36 may have a transceiver 28 and antenna 26 separately from the processor 30 which also has a separate transceiver 28 and antenna 26 of the same type or different. In some embodiments, the processor 30 may route communication received via transceiver 28 to the credential module 36. In other embodiments the credential module may communicate directly to the mobile device 12 through the transceiver 28.

The mobile device 12 generally includes a key antenna 40, a key transceiver 42, a key processor 44, a key memory 46, a GPS receiver 48, an input device 50, an output device 52, and a key power supply 54. The key transceiver 42 is a transceiver of a type corresponding to the lock transceiver 28, and the key antenna 40 is a corresponding antenna 26. In some embodiments, the key transceiver 42 and the key antenna 40 may also be used to communicate with the server 14. In other embodiments, one or more separate transceivers and antennas may be included to communicate with server 14. The key memory 46 is of a type to store a plurality of credentials locally on the mobile device 12. The mobile device 12 may also include a mobile device application 80. Embodiments disclosed herein, may operate through the mobile device application 80 installed on the mobile device 12.

Turning now to FIG. 5, a flow diagram 500 illustrating a method of automatically providing promotions to hotel guests using mobile credentials is generally shown, in accordance with an embodiment of the disclosure. In an embodiment, all or a portion of the processing shown in FIG. 5 is performed by a vendor application, such as vendor application 204 of FIG. 2, and/or a hotel application, such as hotel application 202 of FIG. 2. At block 502, a hotel application, such as hotel application 202 of FIG. 2, displays vendor promotions (also referred to herein as “promotions”) from one or more vendors that are available to guests of the hotel. In an embodiment, the hotel application is executing on a mobile device of a hotel guest, such as mobile 12 of FIGS. 3 and 4. At block 504, the hotel guest selects a vendor promotion from the list of displayed available vendor promotions. The selection can be in any manner known in the art such as, but not limited to touching a location on the screen or via a voice command.

At block 506 of FIG. 5, the hotel guest logs in to the vendor application of the vendor offering the selected vendor promotion. In an embodiment, the logging in happens automatically in response to the selection at block 504. At block 508, the hotel application provides the mobile credential of the hotel guest to the vendor application, and at block 510 the vendor application validates the mobile credential. Processing continues at block 512 with the vendor promotion being made available to the hotel guest if the mobile credential is valid. In an embodiment, the vendor promotion is automatically applied to any business transaction (e.g., a product sale or service arrangement that the vendor promotion applies to) between the vendor and the hotel customer. In an embodiment, the vendor promotion is not made available and not applied to any business transaction between the vendor and the hotel customer if the mobile credential is invalid.

In an embodiment, the mobile credential is encrypted in order to keep the value of the mobile credential private. In this embodiment, the mobile credential can be encrypted by the hotel application before it is sent to the vendor application. The vendor application can then send the encrypted mobile credential to the mobile credential module which has the encryption key. The mobile credential module can then decrypt the encrypted mobile credential to determine whether the mobile credential is valid. Alternatively, the mobile credential module can use the encrypted mobile credential to determine whether the mobile credential is valid.

While the above description has described the flow process of FIG. 5 in a particular order, it should be appreciated that unless otherwise specifically required in the attached claims that the ordering of the steps may be varied.

While embodiments have been described herein in terms of a hotel, it will be appreciated that embodiments can be utilized in any commercial domain (e.g., office workplaces) or educational institutions where people regularly occupy defined locations.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A method of automatically providing access to a vendor application to requestors, the method comprising:
receiving, by a vendor application of a vendor, a request from a requestor to access the vendor application to perform a business transaction between the requestor and the vendor;
receiving, by the vendor application, a mobile credential assigned to the requestor for unlocking an access control device;
determining whether the mobile credential assigned to the requestor is valid; and
based at least in part on determining that the mobile credential is valid, accepting, by the vendor application, the mobile credential and providing the requestor access to the vendor application to perform the business transaction.

2. The method of claim 1, wherein providing the requestor access to the vendor application includes applying a vendor promotion to the vendor transaction between the requestor and the vendor.

3. The method of claim 1, further comprising denying the requestor access to the vendor application based at least in part on determining that the mobile credential is invalid.

4. The method of claim 1, wherein the mobile credential is encrypted.

5. The method of claim 1, wherein the requestor is a hotel guest of a hotel and the access control device is located at the hotel.

6. The method of claim 5, wherein the determining comprises:
transmitting a validation request to a mobile credential module that comprises valid mobile credentials assigned to hotel guests of the hotel, the validation request comprising the mobile credential of the requestor; and
in response to the transmitting, receiving a status of valid or invalid from the mobile credential module.

7. The method of claim 5, wherein the mobile credential is valid between a time that the hotel guest checks into the hotel and a time that the hotel guest checks out of the hotel, and invalid otherwise.

8. The method of claim 5, wherein the hotel guest initiates the request from a hotel application and the promotion was previously negotiated between the hotel and the vendor.

9. The method of claim 5, further comprising:
providing the hotel guest access to a hotel network without any login credentials based at least in part on determining that the mobile credential is valid; and
requiring the hotel guest to provide login credentials to access the hotel network based at least in part on determining that the mobile credential is not valid.

10. The method of claim 1, wherein:
providing the requestor access to the vendor application to perform the business transaction is further based at least in part on determining at least one of: the requestor is within range of a radio frequency transmission, the requestor is within range of a wireless network, the requestor is within a first specified distance of a geographic location, and the requestor is within a second specified distance of a device that uses mobile credentials; and
the requestor is not provided access to the vendor application otherwise.

11. The method of claim 1, wherein:
the requestor is provided access to the vendor application to perform the business transaction further based at least in part on determining that a current time of day is within a specified time period; and
the requestor is not provided access to the vendor application otherwise.

12. The method of claim 1, wherein the business transaction is a purchase of a product or a service.

13. The method of claim 1, wherein the requestor is an employee and the access control device is a location in a building.

14. The method of claim 1, wherein the promotion is at least one of a free product, a discounted product, a free service, and a free product.

15. The method of claim 1, wherein the access control device is located in an office building or a school campus.

16. A system configured to automatically provide vendor promotions to requestors, the system comprising:
a processor; and
a memory comprising computer-executable instructions that, when executed by the processor, cause the processor to perform operations, the operations comprising:
receiving, by a vendor application of a vendor, a request from a requestor to access the vendor application to perform a business transaction between the requestor and the vendor;
receiving, by the vendor application, a mobile credential assigned to the requestor for unlocking an access control device;
determining whether the mobile credential assigned to the requestor is valid; and
based at least in part on determining that the mobile credential is valid, accepting, by the vendor application, the mobile credential and providing the requestor access to the vendor application to perform the business transaction.

17. The system of claim 16, wherein the providing the requestor access to the vendor application includes applying a vendor promotion to the vendor transaction between the requestor and the vendor.

18. The system of claim 16, wherein the operations further comprise denying the requestor access to the vendor application based at least in part on determining that the mobile credential is invalid.

19. The system of claim 16, wherein the requestor is a hotel guest of a hotel and the access control device is located at the hotel.

20. The system of claim 17, wherein the operations further comprise:
providing the hotel guest access to a hotel network without any login credentials based at least in part on determining that the mobile credential is valid; and
requiring the hotel guest to provide login credentials to access the hotel network based at least in part on determining that the mobile credential is not valid.
